(19) United States
(12) Patent Application Publication
(10) Pub. No.: US 2023/0049206 A1
(43) Pub. Date: Feb. 16, 2023

(54) SYSTEM, ARCHITECTURE AND METHODS ENABLING USE OF ON-DEMAND-AUTONOMY SERVICE

(71) Applicant: GM GLOBAL TECHNOLOGY OPERATIONS LLC, Detroit, MI (US)

(72) Inventors: Ramesh Sethu, Troy, MI (US); Arun Adiththan, Sterling Heights, MI (US); Prakash Mohan Peranandam, Rochester Hills, MI (US)

(73) Assignee: GM GLOBAL TECHNOLOGY OPERATIONS LLC, Detroit, MI (US)

(21) Appl. No.: 17/445,075

(22) Filed: Aug. 13, 2021

(51) Int. Cl. G07C 5/00; B60W 60/00; B60W 50/14; G06N 20/00; H04W 4/46

(52) U.S. Cl. CPC G07C 5/008; B60W 60/001; B60W 50/14; G06N 20/00; H04W 4/46; B60W 2050/143

(57) ABSTRACT

Systems and methods for an On-Demand Autonomy (ODA) service. The system includes a set of functional modules enabled for ODA service activities disposed in a follower vehicle (Fv) in communication with an ODA server that includes a user request module configured to receive request information from the Fv from the ODA server, and to process and communicate the request information to the schedule module; the schedule module configured to coordinate an arrival time information with the ODA server for pickup of the Fv based on the request information, and communicate the arrival time information to the schedule execution module; the schedule execution module configured to direct the Fv to a pickup point based on the arrival time information, and communicate the pickup point to the indication module; and the indication module configured to provide alerts to vehicles in the vicinity of the pickup of the Fv via the ODA service.

### INTRODUCTION

The present disclosure generally relates to semi-autonomous/autonomous vehicles and more particularly relates to systems and methods for an On-Demand Autonomy (ODA) service, and more particularly relates to systems and methods to communicate parameters, safety events, interrupts of failure, and responses in control for a vehicle that is configured with minimum viable capabilities, and does not fully installed components for autonomous operations, and is requesting the ODA service.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from a positioning system including global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Accordingly, it is desirable to provide systems and methods for an On-Demand Autonomy (ODA) service that extends a platoon and implements multiple control systems configured with software to provide an on-demand autonomy to vehicles that are not built for full autonomy and a feature set that enables the minimum viable capabilities of vehicles to request and implement the ODA service.

Furthermore, other desirable features and characteristics of the present invention will become apparent from the subsequent detailed description of the invention and the appended claims, taken in conjunction with the accompanying drawings and the background of the invention.

### SUMMARY

A system is disclosed for an on-demand (ODA) autonomy service.

An On-Demand Autonomy (ODA) system is provided. The ODA system includes a set of functional modules enabled for ODA service activities disposed in a follower vehicle (Fv) in communication with an ODA server including at least a user request module, a schedule module, a schedule execution module, and an indication module, wherein the set of functional modules further include: the user request module configured to, by a processor, receive request information from the Fv from the ODA server, and to process and communicate the request information to the schedule module; the schedule module configured to, by the processor, coordinate an arrival time information with the ODA server for pickup of the Fv based on the request information, and communicate the arrival time information to the schedule execution module; the schedule execution module configured to, by the processor, direct the Fv to a pickup point based on the arrival time information, and communicate the pickup point to the indication module; and the indication module configured to, by the processor, provide alerts to vehicles in a vicinity of the pickup of the Fv via the ODA service.

In an embodiment, the system further includes the user request module configured to, by the processor, send automatically an offer or an alert to use the ODA service to the Fv by the ODA server based on a set of criteria associated with received operating data of vehicle behavior of the Fv wherein the operating data of vehicle behavior is monitored by the ODA server when the Fv is connected to the ODA service but not using the ODA service.

In an embodiment, the system further includes the user request module configured to, by the processor, proactively suggest the use of the ODA service to the Fv by communications from the ODA server based on learned data from artificial intelligence model, or a machine learning model of data associated with Fv operations.

In an embodiment, the system further includes the schedule module configured to, by the processor, determined by an iterative process pairing of the Fv based on a value score which is cost-benefit assessment using a set of modeled weighted factors of the Fv, that is independently computed by the Fv, and coordinating requests between the Fv and one or more leader vehicles (Lvs) to confirm acceptance of a virtual link between the Fv and Lv to create a vehicle platoon.

In an embodiment, the system further includes the schedule module to enable selection of a schedule for the Fv and configured to, by the processor: receive schedule information associated with costs from the ODA server which have been calculated based on a complex function including at least end to end time; and present a set of options to the Fv for the selection wherein the set of options include start and endpoint of the ODA service, and a number of transfers, if necessary, with multiple leader vehicles (Lvs).

In an embodiment, the system further includes the schedule execution module configured to, by the processor, initiate a schedule and virtual link between the Fv to a leader vehicle (Lv), and monitor with continuous status updates operations of the Fv for at least an unlink action at an end of a route.

In an embodiment, the Fv is at least categorized as a level two vehicle with at least the capability to communicate with the ODA server, to create a virtual link with a leader vehicle (Lv), and to relinquish control to the Lv in a vehicle platoon.

In an embodiment, the Lv is at least categorized as the level two vehicle with at least a capability to communicate with the ODA server, to create the virtual link with the Fv, and to perform the control of the Fv for the ODA service.

In an embodiment, the system further includes the indication module configured to, by the processor, indicate vehicle positioning of the Fv to the ODA service for at least a linking operation to create a virtual link.

In an embodiment, the virtual link enables the Fv to simulate vehicle operations of a higher level of autonomous driving capability without the Fv having been actually configured with the higher level of autonomous driving capability.

In another embodiment, a method for an On-Demand Autonomy (ODA) service is disclosed. The method includes: configuring a set of functional modules including at least a user request module, a schedule selection module, a schedule execution module, and an indication module for ODA service activities disposed in a follower vehicle (Fv) for communicating with an ODA server by: configuring the user request module, by a processor, for receiving request information from the Fv from the ODA server, and for processing and communicating the request information to the schedule selection module; configuring the schedule selection module, by the processor, for coordinating an arrival time information with the ODA server for picking up of the Fv based on requesting information, and communicating the arrival time information to the schedule execution module; configuring the schedule execution module, by the processor, for directing the Fv for picking up at a point based on the arrival time information, and for communicating a pickup point to the indication module; and configuring the indication module, by the processor, for alerting vehicles in a vicinity of picking up of the Fv via the ODA service.

In an embodiment, the method further includes sending by the user request module, by the processor, automatically an offer or an alert for using the ODA service to the Fv by the ODA server based on a set of criteria associated with operating data of vehicle behavior of the Fv wherein the operating data of vehicle behavior is monitored by the ODA server.

In an embodiment, the method includes suggesting by the user request module, by the processor, use of the ODA service to the Fv by communications from the ODA server based on learned data from artificial intelligence model, or a machine learning model of data associated with Fv operations.

In an embodiment, the method includes determining by the schedule selection module, by the processor, via an iterative process of a pairing of the Fv based on a value score which is a cost-benefit assessment using a set of modeled weighted factors of the Fv independently computed by the Fv, and coordinating requests between the Fv and one or more leader vehicles (Lvs) to confirm acceptance of a virtual link between the Fv and Lv for creating a vehicle platoon.

In an embodiment, the method includes selecting by the schedule selection module, by the processor, a schedule for the Fv by receiving schedule information associated with costs from the ODA server which have been calculated based on a complex function including at least end to end time; and presenting a set of options to the Fv for user selection wherein the set of options include a start point and an endpoint of the ODA service, and a number of transfers, if necessary, with multiple leader vehicles (Lvs).

In an embodiment, the method includes initiating by the schedule execution module, by the processor, the schedule and virtual link between the Fv to a leader vehicle (Lv), and monitoring with continuous status updates operations of the Fv for at least an unlink action at an end of a route.

In an embodiment, the Fv is at least categorized as a level two vehicle with at least the capability to communicate with the ODA server, to create a virtual link with a leader vehicle (Lv), and to relinquish control to the Lv in a vehicle platoon, and wherein the Lv is at least categorized as the level two vehicle with at least the capability to communicate with the ODA server, to create the virtual link with the Fv, and to perform the control of the Fv for the ODA service.

In an embodiment, the virtual link enables the Fv to simulate vehicle operations of a high level of autonomous driving capability without the Fv having been actually configured with the high level of autonomous driving capability.

In an embodiment, the method includes indicating by the indication module an appropriate positioning of the Fv to the ODA service for at least a linking/unlinking operation to create/release a virtual link between the Fv and Lv.

In yet another embodiment, an autonomous vehicle configured for a follower vehicle (Fv) is disclosed. The autonomous vehicle includes a processor in communication with an On-Demand Autonomy (ODA) server including a set of functional modules of at least a user request module, a schedule selection module, a schedule execution module, and an indication module for ODA service activities including creation of a virtual link to the Fv to configure a vehicle platoon disposed in a follower vehicle Fv wherein the virtual link enables the Fv to simulate vehicle operations of a high level of autonomous driving capability without the Fv configured for the high level of autonomous driving capability, the processor configured to: receive, by the user request module, information of requests from the Fv from the ODA server, and to process and communicate the information of the requests to the schedule selection module; coordinate, by the schedule selection module an arrival time information with the ODA server to pick up the Fv based on requested information, and communicate the arrival time information to the schedule execution module; direct by the schedule execution module, the Fv to pick up at a point based on the arrival time information, and to communicate a pickup point to the indication module; and alert by the indication module, vehicles in a vicinity of the pickup at the point of the Fv via the ODA service.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an exemplary autonomous vehicle for use with the On-demand Autonomy service, in accordance with various embodiments;

FIG. 2 is a functional block diagram illustrating a transportation system having one or more autonomous vehicles of FIG. 1, in accordance with various embodiments;

FIG. 3 is a dataflow diagram illustrating an autonomous driving system that includes an On-demand Autonomy system of the autonomous vehicle, in accordance with various embodiments;

FIG. 4 is a diagram of modules and other entities and the data flow therebetween of ODA system of the autonomous vehicle, in accordance with various embodiments;

FIG. 5 is a chat depicting sequences or requests between modules and other entities and the data flow therebetween of the ODA system of an autonomous or semi-autonomous vehicle, in accordance with various embodiments;

FIG. 6 is a diagram of modules and other entities and the data flow therebetween of ODA system of the autonomous vehicle, in accordance with various embodiments;

FIG. 7 is a diagram of modules and other entities and the data flow therebetween of ODA system of the autonomous vehicle, in accordance with various embodiments;

FIG. 8 is a diagram of modules and other entities and the data flow therebetween of ODA system of the autonomous vehicle, in accordance with various embodiments;

FIG. 9 is a diagram of modules and other entities and the data flow therebetween of ODA system of the autonomous vehicle, in accordance with various embodiments;

FIG. 10 is a diagram of modules and other entities and the data flow therebetween of ODA system of the autonomous vehicle, in accordance with various embodiments;

FIG. 11 is a diagram of modules and other entities and the data flow therebetween of ODA system of the autonomous vehicle, in accordance with various embodiments; and

FIG. 12 is a flowchart illustrating a control method for controlling the autonomous vehicle based on the ODA system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application-specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In various exemplary embodiments, the present disclosure provides systems and methods for an On-Demand Autonomy (ODA) service that extends a platoon and implements multiple control systems configured with the software of one or more leader vehicles (Lvs) coordinated to form virtual links using a distributed protocol with at least one subordinate or follower vehicles (Fvs) for guidance in an on-demand price model from one location to another for an on-demand service where some, most or all of either the Lvs and/or Fvs have been configured with minimum viable capabilities to request and confirm ODA service in response to communications broadcast and requests from a cloud-based ODA server.

In the various exemplary embodiments, the present disclosure describes the minimum viable capabilities of vehicles requesting the ODA service of the feature set of the capability to communicate the essential and optional parameters required for the ODA service request, to communicate vehicle health parameters and preferences (e.g., multi-stop vs trip time/distance) to a central ODA server, and processes to receive commands and appropriately activate the actuators for the required sensor and vehicle information to send to other agents for the vehicle to vehicle (V2V)/vehicle to infrastructure (V2I) connected features for communication with leader vehicle(s) and the On-Demand Autonomy Server (ODAS).

In various exemplary embodiments, the present disclosure describes systems and methods to communicate parameters required for the ODA service that include communicating minimal vehicle (Lv and Fv) health parameters (e.g., battery/oil life) and personal preferences, generating and communicating various safety events or interrupts to server and leader(s) (e.g., rear left the door open).

In various exemplary embodiments, the present disclosure describes systems and methods of an ODA system configured with a finite-state machine-based intermittent failure (e.g., transient coupling interference due to traffic) handling with onboard detection and response system

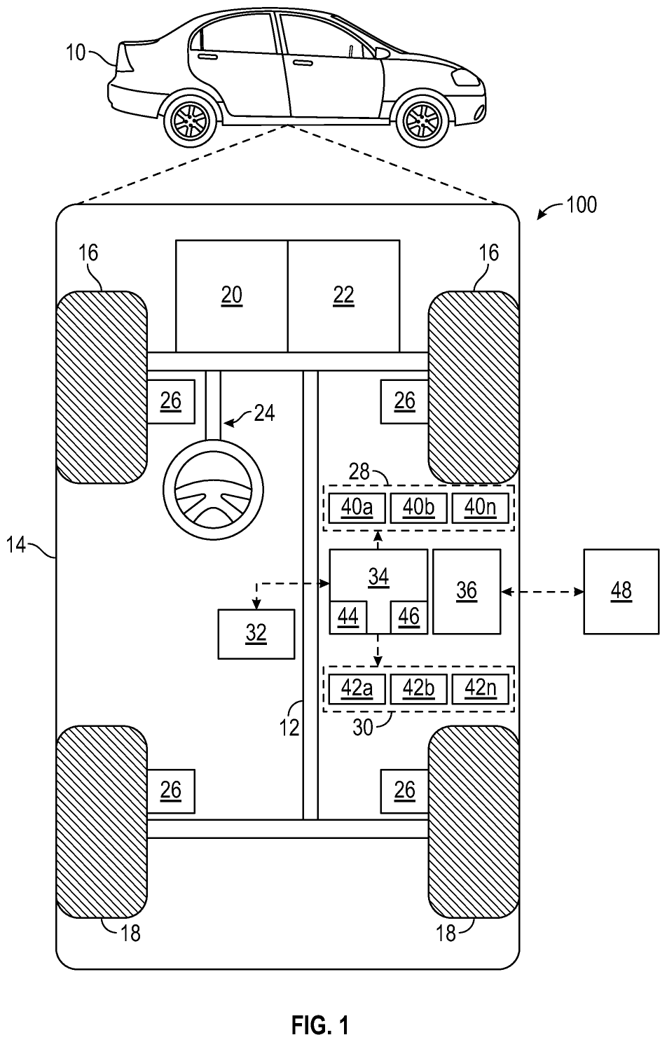

With reference to FIG. 1, an on-demand autonomy (ODA) system shown generally at 100 is associated with a vehicle 10 in accordance with various embodiments. In general, the on-demand autonomy (ODA) system 100 is implemented in an on-demand autonomy (ODA) service that enables one or more LVs to receive a request and to compute independently based on a price metric provided by an ODA server or using a utility function in response to the request to confirm an acceptance to the request and create a virtual link with a follower vehicle (Fv) to control the Fv by communication links, and control systems of the vehicle 10.

In an exemplary embodiment, the ODA service includes an ADS-equipped vehicle (i.e., vehicle 10) that may extend its autonomous driving capability to other vehicles on request. Vehicle 10 is configured to lead a non-AV vehicle with little attention from the driver of the latter from point A to point B.

In exemplary embodiments, the follower vehicle (Fv) may be configured with a private space for the occupants so that they can relax or attend to work. The leader vehicle (Lv) is capable of picking up and dropping the following vehicle safely at selected locations. The Fv is in constant communication with the ODA server throughout the journey including the initial phase of allocation and the final phase of dropping. The Lv can pick up one or more of the vehicles to follow to the drop-off. The Lv and Fv are configured with V2V and V2I communication capabilities.

As depicted in FIG. 1, vehicle 10 generally includes a chassis 12, a body 14, front wheels 16, and rear wheels 18. Body 14 is arranged on chassis 12 and substantially encloses components of vehicle 10. Body 14 and chassis 12 may jointly form a frame. The wheels 16-18 are each rotationally coupled to the chassis 12 near a respective corner of the body 14.

In various embodiments, vehicle 10 is autonomous, and the ODA system 100 is incorporated into the autonomous vehicle 10 (hereinafter referred to as the autonomous vehicle 10). The autonomous vehicle 10 is, for example, a vehicle that is automatically controlled to carry passengers from one location to another. Vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

In an exemplary embodiment, the autonomous vehicle 10 is a so-called Level Two, Two plus, Three, Four, or Level Five automation system. A level Two or Two plus system indicates a system that has capabilities to create and confirm a virtual link and enable an Lv to control the Fv to a requested location where the Fv has relinquished control of vehicle operation to the Lv.

A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously variable transmission, or other appropriate transmissions. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences the position of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

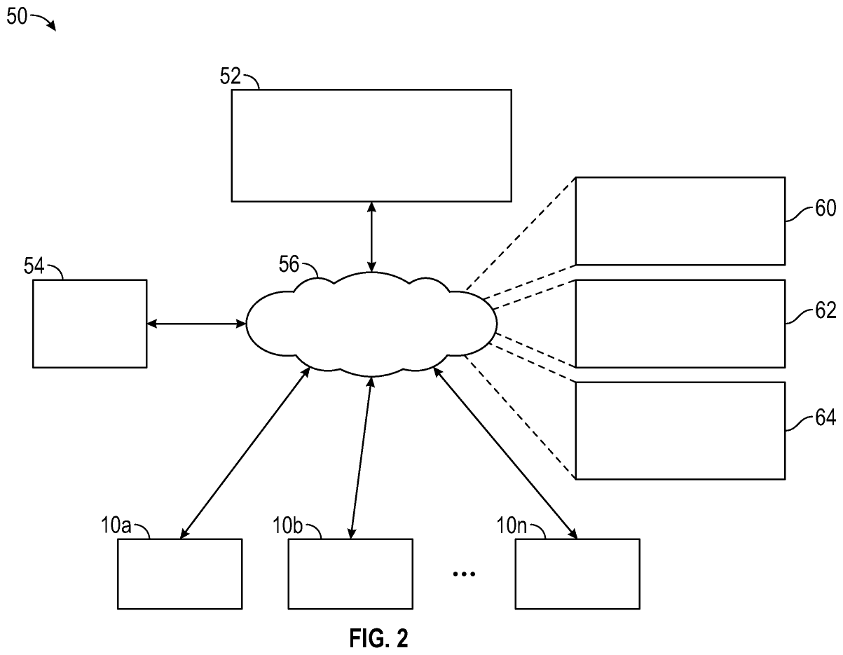

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of controller 34, separate from controller 34, or part of controller 34 and part of a separate system.

The controller 34 includes at least one processor 44 and a computer-readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the ODA system 100 and, when executed by the processor 44, including the processing of requests including receiving and accepting requests from a remote cloud ODA server, processing instructions, various decision-making responses, monitoring for broadcast messages associated with the virtually made vehicle leader and follower configurations, and providing status information for an ODA service.

With reference now to FIG. 2, in various embodiments, the autonomous vehicle 10 described with regard to FIG. 1 may be suitable for use in the context of a taxi or shuttle system in a certain geographical area (e.g., a city, a school, or business campus, a shopping center, an amusement park, an event center, or the like) or may simply be managed by a remote system. For example, the autonomous vehicle 10 may be associated with an autonomous vehicle-based remote transportation system.

FIG. 2 illustrates an exemplary embodiment of an operating environment shown generally at 50 that includes an autonomous vehicle-based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices (i.e., Lv, Fv, and ODA server), systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including, for example, digital technologies such as CDMA (e.g., CDMA2000), LTE (e.g., 4G LTE or 5G LTE), GSM/GPRS, or other current or emerging wireless technologies. Other cell towers/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62 but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smartwatch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle-based remote transportation system 52. To this end, an autonomous vehicle and autonomous vehicle-based remote transportation system can be modified, enhanced, or otherwise supplemented to provide the additional features described in more detail below.

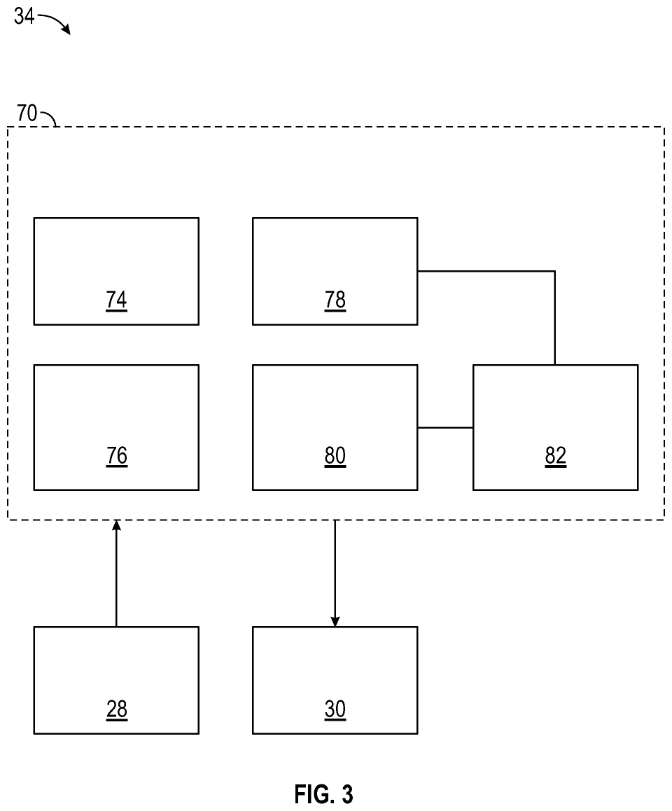

In accordance with various embodiments, controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to the lane of a road, vehicle heading, velocity, etc.) of the vehicle 10 relative to the environment. The guidance system 78 processes sensor data along with other data to determine a path for vehicle 10 to follow. For example, a path to a pick-up or drop-off location for the ODA service. The vehicle control system 80 generates control signals for controlling the vehicle 10 according to the determined path.

In various embodiments, controller 34 implements machine learning techniques to assist the functionality of controller 34, such as feature detection/classification, obstruction mitigation, route traversal, mapping, sensor integration, ground-truth determination, and the like.

As mentioned briefly above, the ODA system 100 of FIG. 1 is included within the ADS 70, for example, as the ODA system 82 that provides communication requests, for example in one embodiment of Host vehicle configured for vehicle 10 to receive requests broadcast from an on-demand autonomy server configured with the autonomous based transportation system 52. Also, in another embodiment of Robot Taxi (leader vehicle Lv) configured for vehicle 10 to accepts broadcast from an on-demand autonomy server configured with the autonomous-based transportation system 52.

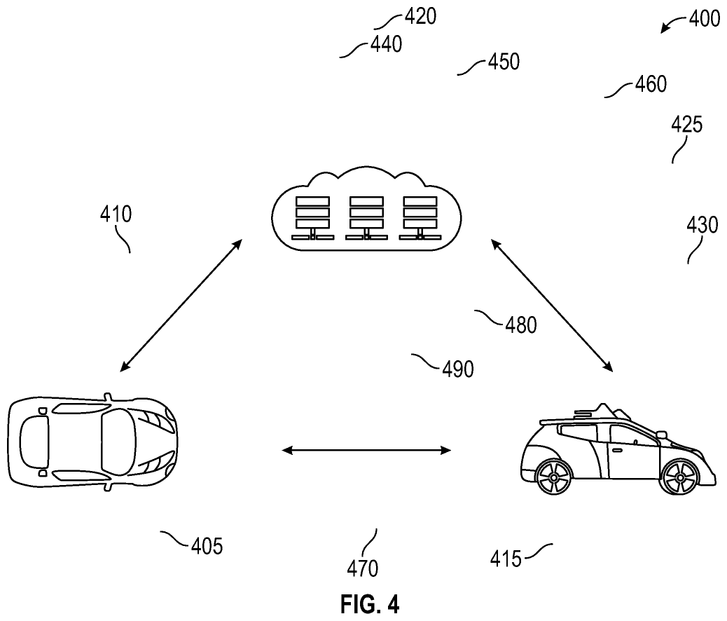

For example, as shown in more detail with regard to FIG. 4 and with continued reference to FIG. 3, the ODA system 82 includes functionality in response to the request from an on-demand server to provide information about the vehicle 10 current status and a variety of different parameters, e.g. current location, distance, time to a location, type of vehicle, availability, ability to initiate virtual coupling, etc. for the ODA service to make the appropriate leader vehicle LV and follower vehicle FV selections.

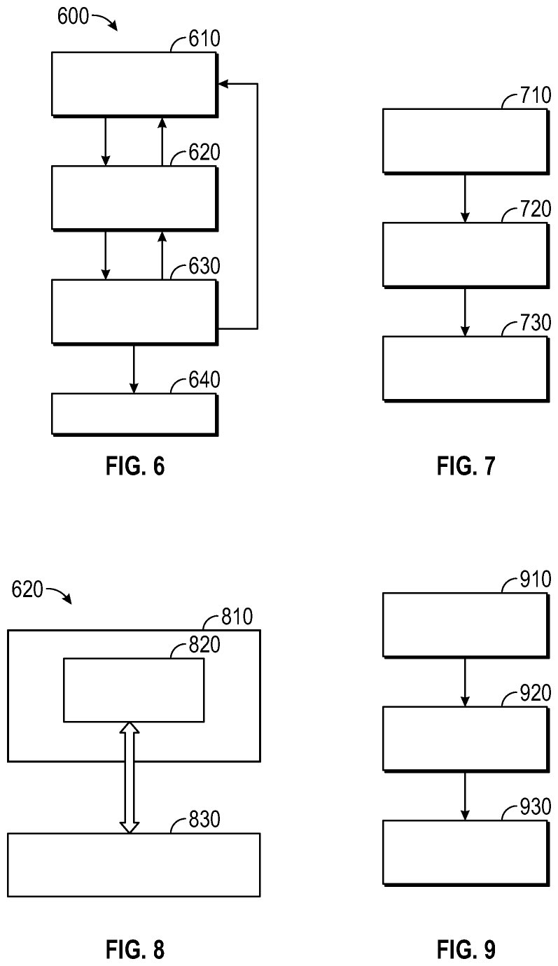

In embodiments, the ODA system 82 includes a set of modules described in more detail in FIGS. 6-12 of a user request module, a schedule selection module, a schedule execution module, and an indication module for ODA service activities disposed of in a follower vehicle (Fv) for communicating with an ODA server by receiving requests by the user request module of information from the Fv from the ODA server, and for processing and communicating the request information to the schedule selection module; by coordinating by a schedule selection module an arrival time information with the ODA server for picking up of the Fv based on requesting information, and communicating the arrival time information to the schedule execution module; by directing by the schedule execution module for directing the Fv for picking up at a point based on the arrival time information, and for communicating the pickup point to the indication module by alerting by the indication module, by the processor, for alerting vehicles in the vicinity of picking up of the Fv via the ODA service.

In embodiments, the ODA system 82 includes capabilities to confirm the acceptance to request from the ODA server and to create a virtual link between the Lv and Fv. The ODA system 82 includes processing capabilities to independently make decisions based on price metrics and a set of weighting factors using a utility function that is specified as executed by the ODA server and cost values are sent to the Lv and Fv for approval or rejection. In an embodiment, the Fv is configured with its own intelligent model or application for calculating its value score and makes an independent decision whether to accept a request from an ODA server that has been broadcast to a number of Lvs, where the ODA server is coordinating the acceptances of multiple Lvs, and Fvs for requested location assistance and control of Fvs.

In an embodiment, multiple agents or entities consisting of the ODA server, the Lv, and the Fv each are configured with intelligent models/algorithms/modules to determine and generate a cost/value score for the ODA service that is calculated based on factors personal to each entity, or executing the cost/value score with each entity own perspective taken into account. The ODA system 82 includes processing capabilities to weigh multiple factors and to link and unlink an Lv in a multi-stage segmented route requested by the ODA server in response to assistance solicited for route control and navigation by an Fv. The ODA system 82 has the processing ability to participate in a vehicle platoon configured in response to responses solicited by the ODA server, where the Lv is replaced one or more times on a multi-segmented route to the requested destination as configured by the ODA server.

In embodiments, the ODA system 82 may include a neural network engine that has been trained for the objects of interest to vehicles, in one embodiment, that includes trained data, trained processes in the form of computer program instructions, and a processor for executing those instructions. Such objects of interest that form part of the training of the neural network engine include locations of interest, prior virtual couplings of an Fv and Lv, prior pickups, prior information about drop-off locations that the vehicle has performed, and cost metrics and route pricing information, etc. . . . .

The exemplary embodiment of the ODA system 82 of FIG. 4 is included in the autonomous driving system 70. The autonomous driving system 70 is configured to execute steering and speed control maneuvers, amongst other possible autonomous driving possibilities, to avoid collisions and to move cooperatively with tracked objects based in part on the control commands. The autonomous driving system 70 operates known autonomous vehicle control computer instructions through a processor-based in part on the control data, as described above with respect to FIG. 3

FIG. 4 shows a communication network of the on-demand service 400 between the various leader and Fvs in communication with cloud OAD server to configure virtual couplings between the various leader and follower vehicles in accordance with an embodiment.

In various exemplary embodiments, the on-demand autonomy (ODA) service 400 can configure a platoon to consist of one Lv configured to guide one or more FVs from one point to another in the ODA service.

In various exemplary embodiments, the present disclosure provides systems and methods of an On-Demand Autonomy (ODA) service that implements one or more electronic control systems and software, built on top of a platooning service that accepts requests from other vehicles via an ODA server (ODAS), selects one or more FVs, selects one or more FVs up at pre-decided points, commands the FVs to follow a selected one of multiple LVs in a vehicle platoon for navigation, guidance, and instruction for dropping off of one or more of the FVs at various designated points.

In various exemplary embodiments, the present disclosure provides systems and methods with one or more LVs serving or instructing one or more FVs configured with enhanced overheads like increased time and resources but compensated for based on a price metric generated by the ODA service using a cost-benefit (investment) model via an intelligent algorithm based on multiple weighted factors including for the more responsibilities and increases in equipment to provide increased revenue to the selected Lv.

In various exemplary embodiments, the present disclosure provides systems and methods that enable one or more LVs to receive a request and to compute or assess independently using a utility function or model in response to the request and information provided to properly fulfill or meet the request. The Lv may determine whether to confirm the acceptance of the request using an intelligent model-based upon different parameters, e.g., route of the requests, weather, lighting, revenue, etc. and to make a selection that maximizes the parameters made available of the utility function in offering the on-demand service.

In various exemplary embodiments, the present disclosure provides systems and methods of an On-Demand Autonomy (ODA) service that implements one or more electronic control systems and software, built on top of a platooning service that accepts requests from other vehicles via an ODA server (ODAS), selects one or more FVs, selects one or more FVs up at pre-decided points, commands the FVs to follow a selected one of multiple LVs in a vehicle platoon for navigation, guidance, and instruction for dropping off of one or more of the FVs at various designated points.

In various exemplary embodiments, the present disclosure provides systems and methods with one or more LVs serving or instructing one or more FVs configured with enhanced overheads like increased time and resources but compensated for based on a price metric generated by the ODA service using a cost-benefit (investment) model via an intelligent algorithm based on multiple weighted factors including for the more responsibilities and increases in equipment to provide increased revenue to the selected Lv.

In various exemplary embodiments, the present disclosure provides systems and methods that enable one or more LVs to receive a request and to compute or assess independently using a utility function or model in response to the request and information provided to properly fulfill or meet the request. The Lv may determine whether to confirm the acceptance of the request using an intelligent model based upon different parameters, e.g., route of the requests, weather, lighting, revenue, etc. and to make a selection that maximizes the parameters made available of the utility function in offering the on-demand service.

In various exemplary embodiments, the on-demand autonomy (ODA) service 400 can configure a platoon to consist of multiple leader vehicles (Lvs) configure amongst multiple segments of a route from with one or more follower vehicles (Fvs) about each route segment that makes up the route from one point to another point in the on-demand service.

In various exemplary embodiments, the on-demand autonomy (ODA) service 400 can put forth a pricing model for a configured vehicle platoon that is made up of multiple route segments where each route segment can include differently created virtual links between different Lvs and an Fv.

In exemplary embodiments, the ODA server (ODAS) 425 can be configured to enable multiple Lvs to accept requests coordinated by the ODA server with the Fv to create multiple virtual links between multiple sets of Lvs and Fvs to make up the route from one point to another in the on-demand service.

In FIG. 4, the ODA system 100 includes functionality to communicate with the on-demand autonomy (ODA) service 400 between a host (e.g., service requestor or Fv) 405, an on-demand autonomy server 425, and Robo taxi (e.g., leader or Lv) 415. The ODA service 400 includes the functionality of receiving requests 410 that are transmitted between the on-demand autonomy server (ODAS) 425 and the host 405, and accepted responses 430 that are transmitted between the on-demand autonomy server 425 and the Robo taxi 415 to initiate a trip (or virtual coupling between the Lv and Fv) 470.

The ODA server 425 performs ODA service 400 functionalities to initiate the trip 470 and cause the virtual coupling between the Lv and Fv by initially broadcasting a request 420 for acceptance by a Robo taxi 415 whereupon the broadcast request 420 is accepted by an affirmation or an accept response 430 by a Robo taxi 415 or in an exemplary embodiment, by multiple Robo taxis (not shown).

In an exemplary embodiment, the ODAS 425 may automatically put forth a notification to a driver or an Fv to initiate a request 420 for a trip 470 based on input data from the Fv including poor driving, difficult driving conditions based on weather reports, etc. In an exemplary embodiment, the ODAS 425 may promote various pricing for the Fv to initiate the request 420 to create a virtual link with the Lv.

The ODA server 425 using a decision-making intelligent algorithm elects a leader 440 which consists of one or more Robo Taxi(s) 415. In other words, based on multiple inputs that include the current state of the vehicle, route of the vehicle, weather, passenger preference, follower pick-up/drop-off locations, and past history, etc. the elected leader or leaders 440 are both identified and selected. The ODA server 425 identifies a rendezvous 450 and communicates trip details 460 to the host and leader to execute an on-demand action.

In an exemplary embodiment, the Fv may request assistance to a location without actually having to perform driver operation. For example, the Fv may be configured with Level 2 plus capabilities that provide limited autonomous vehicle operations yet have communication capabilities to make requests for an on-demand service, enable a virtual link with the Lv where the Lv can be given sufficient operational control to virtual link and virtually tow the Fv to the desired location without the driver of the Fv actually having to operate the Fv.

In an exemplary embodiment, the ODA service 400 can transport the Fv in a platoon configuration with the Lv for enabling an autonomous driving experience (i.e., a level 4 or 5 autonomous driving experience) without the Fv actually being configured or having level 4 or 5 autonomous driving capabilities. That is, by creating a virtual link between the Lv and Fv, the Fv can operate in a semi or nearly autonomous manner by reliance on the control operations provided by the Lv. In an embodiment, by relying on the Lv for control and navigation to the requested location, the Fv can simulate an autonomous driving experience without actually being configured with the necessary software, hardware, and control system for level 4 or 5 autonomous driving capabilities.

In an exemplary embodiment, the driver of the Fv may desire a more autonomous driving experience and is willing to relinquish vehicle control for a route segment or entire route to the Lv. In this case, the follower vehicle (Fv) may send a request 420 to an ODAS 425, the ODAS 425 would coordinate pricing and selection of an Lv using a distributed protocol to solicit requests from multiple Lvs, and to enable a virtual link between the Fv and Lv, to perform a virtual towing operation to the desired location chosen by the Fv.

In various embodiment, multiple Lvs may be coordinated by the ODAS 425 to assist the Fv where the Fv is coupled by consecutive virtual links to multiple different Lvs selected in a coordinated process (i.e., distributed protocol solicitation of requests by the ODAS 425) from a group of Lvs identified by the ODAS 425, and who independently make a decision to accept a request based on a value score for the route or route segments and can enable a virtual link with the Fv in the vehicle platoon configuration as put together by the ODAS 425.

In the various exemplary embodiment, the Fv in the linking operation creating the virtual link with the Lv is given the option to accept the linking request with a value score (or price metric) for the assistance provided by one or more Lvs. In this case, the ODAS 425 coordinates a set of responses from the Fv and one or more Lvs to complete or confirm a solicitation for a virtual link to control the Fv to the requested location based on a proposed price (i.e., value score/cost metric). The proposed price may be for the entire route, or a route segment where the decision to complete or confirm the transaction (i.e., the handshake between both parties) is coordinated by the ODAS 425.

In an exemplary embodiment, the cost metric or price charge by the Lv may be computed by the Lv independently or by the ODAS 425. The price charge, as an example, can be determined using a weighting factor for parameters of a set of parameters based on empirical testing and past history of Fv and Lv operations in the ODS service. The weighting factors may allow for modeling of more accurate value scores, and for adjusting the value score to take into account revenue decreases and ride diffraction that can be applied if the Fv elects not to confirm the acceptance to the request from the ODAS 425.

In an exemplary embodiment, the ODAS 425 may put constraints such as time to accept, demand pricing to accept, or other real-time constraints to the proposed price for the assistance to be provided by the Lv to enable timely completion of the request and formation of virtual link between the Lv and Fv. In another embodiment, the Lv or a set of Lvs may respond to a request broadcasted (i.e., a broadcast of information) by the ODAS 425 based on a value score that the ODAS 425 computes based on a set of weighted factors for the route and for assisting the Fv in the virtual tow operation to a destination requested. The Lv may be given a window of time to respond to the request and to agree to the value score (i.e., price proposed to assist) for the route, route segment, multiple route segments, etc. as presented by the ODAS 425, and likewise, the Fv would be given a similar type of time constraint to make a decision. Once, the handshake or agreement is made by the coordinated process via the distributed protocol implemented by an algorithm of the ODAS 425 the platoon is configured by the created virtual links to assist the Fv for the route request.

In various exemplary embodiments, the Lv may have a set of preferences, and a set of capabilities that can be provided to the ODAS 425 that can change the value score, or make the Lv, a more optimal choice to engage with the follower vehicle Fv for the route assistance and provide the virtual towing operation via the virtual link. In an exemplary embodiment, the Lv can be an advanced fully automated vehicle with Level 4 or Level 5 capabilities that can respond to the ODAS 425 in an automated manner. For example, the Lvs may be a fleet of pre-designated Robo-taxis with pre-configured capabilities to virtual link with Fvs to enable Fv with semi-autonomous or only communication capabilities for Lv autonomous control to traverse a route via a configured vehicle platoon by the ODAS 425 in an autonomous driving way.

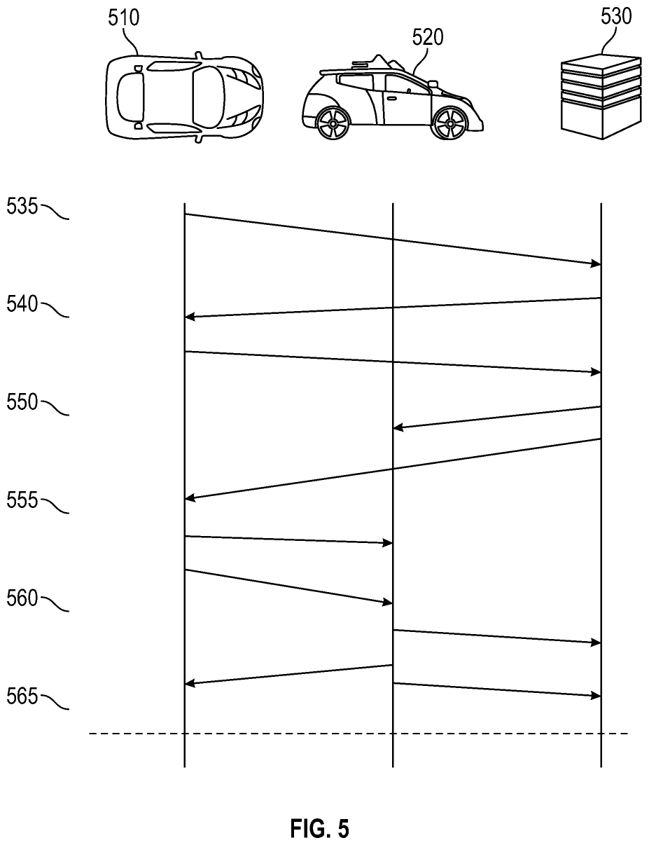

FIG. 5 is an exemplary diagram of a timing chart of the interaction of the ODA server, the host vehicle or Fv, and the Robo Taxi or Lv of the ODA service in accordance with various embodiments. In FIG. 5, in an embodiment, at an initial time 535 (Time T1), the Fv 510 requests to use the ODA service for a location that is transmitted to the ODA server 530. The ODA server 530 responds to the request received by using a distributed protocol to coordinate a set of solicitations for response amongst a group of Lvs and send Lv information to the Fv 510 at a time 540 (Time T2). In response, and with confirmation of the leader selection information at a time 550 (Time T3), the ODA server 530 then or nearly simultaneously sends a confirmation of acceptance to the Fv 510 at a time 555 (Time 4). Also, at time 555, the platoon request is sent to the Lv 520 to configure the vehicle platoon via the virtual link. At time 555 (Time T5), the platoon link is received by the Lv 520 and the ODA service is confirmed, and periodic updates are also sent. Finally at time 565 (Time T6), upon the Fv 510 reaching the destination, the virtual link is unlinked between the Lv 520 and Fv 510, and the service completion information is transmitted to the ODA server 530.

FIG. 6 shows a high-level flow diagram of the set of functional modules communicating with each other to achieve the functionality of the follower vehicle (Fv) of the ODA system in accordance with various embodiments. The flow diagram of FIG. 6 can be implemented by computer program instructions stored on a computer-readable medium executed by a processor such as at least one processor 44 (of FIG. 1). The ODA service may be carried out by the modules and sub-modules described in FIG. 6 for example and may also take in further aspects of the ODA system 82 described with respect to FIG. 3.

FIG. 6 includes basic modules of the ODA system 600 disposed in the Fv of a user request processing module 610, a schedule selection module 620, a schedule execution module 630, and an indication module 640. The user request processing module 610 receives request information from the Fv from the ODA server to process and communicate the request information to the schedule selection module 620. The schedule selection module 620 coordinates an arrival time information with the ODA server for pickup of the Fv based on the request information and communicates the arrival time information to the schedule execution module 630. The schedule execution module 630 directs the Fv to a pickup point based on the arrival time information and communicates the pickup point to the indication module 640. The indication module 640 provides information and alerts to vehicles in the vicinity of the pickup of the Fv via the ODA service. The various modules use the underlying drive automation modules (DAS) modules (e.g., for example, described in FIGS. 1-3) and low-level controllers including more basic platoon service controllers. The messages are exchanged between the ODA server and the modules during an on-demand service operation.

In an embodiment, the user request processing module 610 monitors driver behavior, offers ODA service, receives and processes driver requests. The schedule selection module 620 coordinates with the ODA server to arrive at the desired schedule that includes the route, list of LVs, and the pick-up points. The schedule execution module 630 directs the driver to reach the initial pick-up point for the LV and subsequently coordinates with one or more LVs, invokes platooning service, etc. The indication module 640 is responsible for and provides an appropriate indication to the LV and other road vehicles.

FIG. 7 is a diagram of a monitoring and a request module (i.e., sub-modules of the user request processing module 610) of the ODA system in accordance with various embodiments. In FIG. 7, the user request processing module 610 includes components to complete the virtual coupling of the Fv with the Lv, and to communicate with the ODA server. The user state monitoring module 710 is configured in a constant monitoring state (i.e., similar to a watchdog monitoring type system) when the Fv controller (in FIG. 8) is operating or placed in an executing mode and assists in decision making in the selection or deselection of one or more of the leader vehicles (Lv).

In an exemplary embodiment, the sub-modules of the user state monitoring module 710, the request elicitation module 720, and the request processing module 730 (of the user request processing module 610) of the ODA system monitor driver behavior, offers ODA service, receives and processes driver request. The user state monitoring module 710 waits for the driver or Fv to request the ODA service.

In another embodiment, the user state monitoring module 710 is configured to proactively suggest to the driver to use the ODA service using an artificial intelligence model or machine learning model to perceive the driver behavior, the vehicle state, or other criteria. For example, to use learned driver behavior data to perceive that the driver is prone to distraction—phone call, messaging, dozing, etc, and to suggest the use of the ODA service. Other examples can include the ODA service enabled interactively to suggest possible ODA service along a route based on cumulative data collected by the ODA server, and analysis of other vehicle behavior or driver needs.

In an embodiment, the user state monitoring module 710 includes an onboard finite-state machine-based monitoring system that can detect and respond to intermittent failure conditions—switch to failsafe mode. In an embodiment, the user state monitoring module 710 can include an observation-based new event generation mechanism for standard safety-oriented status that shall be communicated with the ODA server and vehicle leader(s).

In an embodiment, the user state monitoring module 710 includes communicate parameters required for the ODA service that include communicating minimal vehicle (Lv and Fv) health parameters (e.g., battery/oil life) and personal preferences, generating and communicating various safety events or interrupts to server and leader(s) (e.g., rear left the door open).

In an embodiment, the request elicitation module 720 may automatically elicit responses based on various offers including offer sales, discounts, variable pricing, and flag Fvs based on multiple different criteria. The request processing module 730 can be configured with time constraints and other constraints to make Fv offers attractive and put in time periods for acceptances and confirmations of requests.

In an embodiment, data of an ODA Lv availability may be obtained from the ODA server, and the server could proactively enable the Lv to target various Fv with advertisements about availability. For example, various age groups of drivers more prone to require assistance could receive targeted advertisements for the ODA service. Also, driving more hazardous routes, or deemed to require more assistance because of various factors including weather conditions could be targeted with advertisements.

FIG. 8 is a diagram of an Fv controller 810 of the schedule selection module 620 connected to the ODA server 830 for making various schedule selection information 820 in accordance with various embodiments. The schedule selection module 620 is controlled by the Fv controller 810 to determine by an iterative process pairing of the Fv based on the best match, and other coordinated factors; for example, a cost-benefit assessment using a set of modeled weighted factors for the Fv and coordinates the match between the Fv and one or more leader vehicles (Lvs) of requests and confirmations to create a vehicle platoon.

In an embodiment, the schedule selection module 620 (i.e., the Fv controller 810 with schedule selection information 820) coordinates with the on-demand autonomy server (ODAS) 830 receives requests from different Fv and Lv modules to make matches. For example, an Fv request in a distributed protocol matching operation is paired with appropriate Lv request(s) and the best match based on each entity's needs and requirements is selected. For example, the best match may depend upon both criteria put forth independently by the Lv and Fv, and the process may require multiple iterative, or round-robin rounds of matching between Lvs, and Fvs, as well as input from both parties and other inputs such as cost/benefit information exchanges between both parties to make a match. The ODAS 830 may use modeling or intelligent algorithms for cost-benefit assessments, and optimization of costs for each party to make a match attractive, and also may have (with constraints) or enable multiple rounds of communication between ODAS and Lv/Fv vehicles directly or indirectly to enable the match and the eventual virtual link between both entities.

FIG. 9 is a diagram of another embodiment of the schedule selection module and various sub-modules for making various schedule selections in accordance with various embodiments. The sub-modules include the schedule option module 910, the compute cost module 920, and the selection of optimal schedule module 930. In an embodiment, the ODAS when requested by the schedule option module 910 may provide a list of schedules and each schedule has a cost associated with each of the items for putting forth a set of comparisons and options associated with ODA requests for both the Fv and Lv in a communication exchange to form an agreement (i.e., to confirm and accept a request for the virtual linking for the ODA service).

In an exemplary embodiment, the compute cost module 920 using a complex function algorithm that can take into account a variety of weight parameters to model a cost of either the Fv of the Lv. For example, the parameters in the functional analysis may include end-to-end time taken for ODA request, the number of transfers requires, type of vehicle chosen as the Lv, weather conditions, traffic conditions, time of day, etc. that can cause increases or decreases in cost. Also, other factors can include time-dependent pricing to confirm a request, and time to make a virtual link operation by the Lv (i.e., Lv availability time to execute ODA operation physically).

In an exemplary embodiment, the Fv may be provided with other options that include start/end points of the ODA service, start times, number of transfers, etc.

In exemplary embodiments, selection algorithm or decision-making steps to schedule selections can be configured based on coordination between the availability status determined of a selected Lv and one or more follower vehicles (Fvs). In this instance, the Fv is subordinated in the decision-making selection role and is selected based on input from the leader vehicle (Lv) only to make the resultant selection. The ODA server 425 based on the Lv communications, executes a distributed protocol that includes multiple Fvs and other Lvs in the communication net that are coordinated to make the selection. The ODA server (ODAS) 425 provides one or more follower vehicle Fv selection based on various parameters that include metrics such as location and availability present or future. The Lv makes a cost-benefit analysis using an intelligent algorithm that weighs multiple criteria that may include the location of the pickup, time to the pickup, the length of the trip, the passenger criteria, etc. of the options presented by the ODA server 425 of the options presented to decide whether to accept the request.

In an exemplary embodiment, the compute cost module 920 can account for the multiple inherent overheads of the Fv can be weighed iteratively for optimum investment analysis in a certain window of time or opportunity for presentation to the Fv. For example, the increase in trip time (t), maneuver complexity (c), passenger comfort (d), and also the likelihood shortly of better or worse costs projected based on history.

In an exemplary embodiment, a value (function) can be modeled with multiple factors, each of which is normalized in real values to generate a value score to the Fv for the cost of the trip. The utility value functional model is as follows: Us=(w1×t)+(w2×c)+(w3×d)+(w4×r)+(w5×u) where wi are appropriate weights. The weights are configured to depend on weather conditions, traffic, time of day, etc. . . . . The values of t, c, d, and r are dependent upon the chosen Lv. The goal of the utility model is to maximize the value of Us among all the Lvs available. The utility value is based upon short-term gains and losses. There can also be long-term benefits and losses in accepting and rejecting Leader vehicle requests, wait time for the next Lv available, etc.

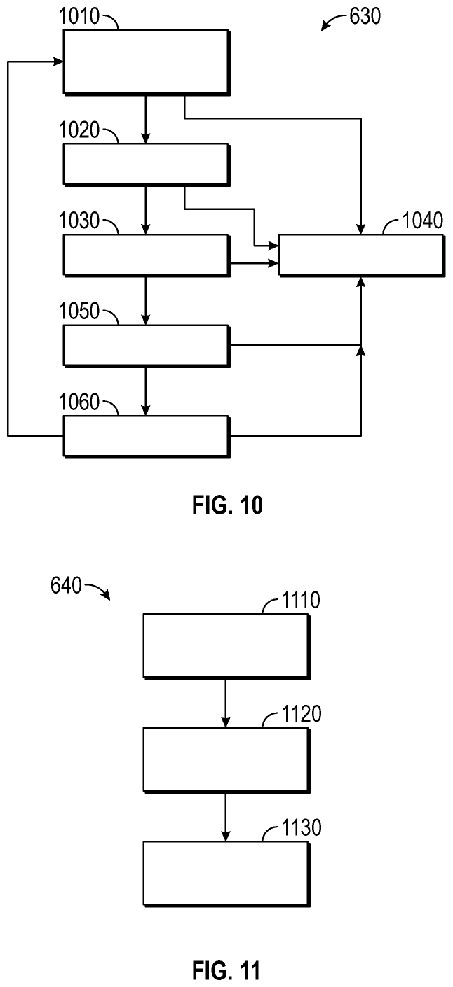

FIG. 10 is a diagram of the schedule execution module 630 and various sub-modules for executing the ODA schedule in accordance with various embodiments. The schedule execution module 630 initiates the schedule and virtual link between the Fv to a leader vehicle (Lv) and monitors with continuous status updates of Fv for the entire ODA service up until the unlink action at an end of a route. The schedule execution module 630 includes the sub-modules of the initiate module 1010 to initiate the schedule in one of several distinct legs or segments. For example, to initiate a first leg of the route and for creating the link and unlink action for this first leg of the route. In another embodiment, the multiple legs can be characterized by distinct Lvs start points, end points, reaching a scheduled destination, the current Lv location, waiting times for linking and creating the virtual link with the Lv, and unlinking waiting times, etc.

The locate module 1020 can be configured to locate the actual location of the Lv and provide up to date or real-time information to the Fv of the Lv location configured on a mapping GUI or other alerts so that the Fv is aware that the Lv is on the route and how far the Lv is away. The link module 1030 can provide the linking times, and locations with more details. The following module 1050 can provide monitoring of the Lv in each of the legs. The unlink module 1060 can provide the unlink location, times, and other details. All the sub-modules can be configured to send data to a monitoring module 1040 that can continuously get status updates, provide appropriate information to the Fv, and provide appropriate information to various top-level modules that operate in the Fv for the ODA service. The various sub-modules operate in an iterative manner or feedback loop throughout the entire trip providing data constantly to the monitoring module 1040.

FIG. 11 is a diagram of the indication module 640 and various sub-modules for executing the ODA schedule in accordance with various embodiments. The indication module 640 enables the appropriate positioning of the Fv to the ODA service in the linking/unlinking operation to create/release a virtual link between the Fv and Lv. The indication module 640 includes the functional blocks of the initialization function 1110, the Fv state monitoring function 1120, and the state-dependent indication module 1130. The indication module 640 is responsible for the Fv to position itself appropriately for linking and delinking, and for enabling other traffic participants to be excluded and kept away (i.e., not within a selection or location to cause interference when possible). The Fv can be configured with lights settings and other indicator mechanisms (i.e., projected type mechanisms) that can be enabled in various states (as monitored by the Fv state monitoring function 1120) including an ON and OFF state. Also, a quasi ON/OFF prior to being in the ON/OFF states, and to provide notice of executions or processes from other modules. For example, certain lighting arrangements can be configured to correspond to various Fv states in operation. The state-dependent indication module 1130 enables the triggering or sequencing of lighting of the Lv or Fv in patterns based on the Lv or Fv status. For example, in an embodiment, the light pattern is indicative of a vehicle 10 as the Fv, and in another embodiment, the light pattern is indicative of vehicle 10 as the Fv in accordance with a sequence or pattern.

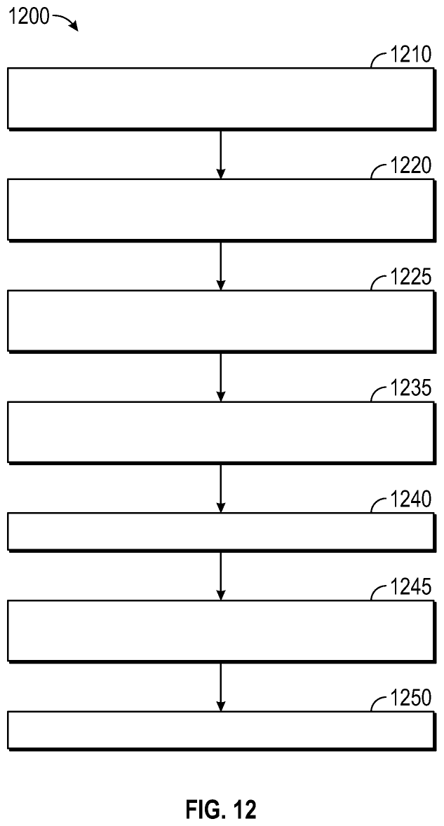

FIG. 12 is a flowchart of the functional processes by the ODA server in operation in conjunction with the Fv of the ODA system in accordance with various embodiments. In embodiments, the process described in the flowchart 1200 for an On-Demand Autonomy (ODA) service includes the steps of communicating and transmitting data by a set of modules of a user request module, a schedule selection module, a schedule execution module, and an indication module for ODA service activities disposed in a follower vehicle (Fv) for communicating with an ODA server. The functionalities of the various modules include receiving requests by the user request module of information from the Fv from the ODA server, and for processing and communicating the request information to the schedule selection module. Next, coordinating by a schedule selection module an arrival time information with the ODA server for picking up of the Fv based on requesting information, and communicating the arrival time information to the schedule execution module. Further, directed by the schedule execution module directions for directing the Fv to perform a pick-up action at a point based on the arrival time information, and for communicating the pickup point to the indication module. The indication module enables a set of alerts for alerting vehicles in the vicinity of the picking-up action of the Fv via the ODA service.

In flowchart 1200, at step 1210, the Fv connected to the ODA server, may via the user request module initially send a request for the ODA service. Alternately, the user request module may automatically send an offer or an alert for using the ODA service to the Fv by the ODA server based on a set of criteria associated with operating data of vehicle behavior of the Fv in which the received operating data of the vehicle behavior is monitored by the ODA server. At step 1220, the user request module may also send alerts for the use of the ODA service to the Fv by communications from the ODA server based on learned data from the artificial intelligence model, or a machine learning model of data associated with Fv operations. At step 1225, the schedule selection module may schedule the ODA service by first determining via an iterative process of a pairing of the Fv based on a cost-benefit assessment using a set of modeled weighted factors of the Fv, and then by coordinating requests between the Fv and one or more leader vehicles (Lvs) to confirm acceptance of a virtual link between the Fv and Lv for creating a vehicle platoon. Next, at step 1230, the schedule selection module may select a schedule for the Fv by receiving schedule information associated with costs from the ODA server which have been calculated based on a complex function including at least end to end time and presenting a set of options to the Fv for user selection wherein the set of options include start and endpoint of the ODA service, and a number of transfers, if necessary, with multiple leader vehicles (Lvs).

At step 1235, the schedule execution module may initiate the schedule and virtual link between the Fv to a leader vehicle (Lv) and continuously monitor for status updates for Fv of processes from the various modules such as operations associated with legs of operation like reaching the scheduled destination, the current Lv location, the following or conveyance by the Lv, and the unlinking from the Lv at an end of a route.

At step 1240, in the various exemplary embodiment, the Fv for the linking operation in creating the virtual link with the Fv, the Fv is given the option to accept the linking request with different pricings based on different options in configuring the linking process. For example, this can include the time to link, the location, and the time it would take for the Fv to get to the link location. The type of Fv and the route segments to link or not to link for an overall sum cost of the ODA server. The proposed price may be for the entire route, or a route segment where the decision to complete or confirm the transaction (i.e., the handshake between both parties) is coordinated by the OD server. Also, variable pricing may be put in place with longer times to hold open a linking option with an Lv, resulting in a higher price to confirm and accept by the Fv.

In an embodiment, the Fv makes an independent decision using a value score that is a cost-benefit directly associated with operating factors for the Fv for the request and can use a plurality of weighted factors to determine a cost charge from the Fv perspective for the Lv to perform the navigation and the control of the Fv to the requested location. In an embodiment, a utility function is specified and executed by the ODA server and cost values are sent to Lv and Fv for approval/rejection. Each entity, the Lv, the Fv, and the ODA server makes an independent decision, and a decision is reached between all 3 entities or a “meeting of the minds” that is coordinated by the ODA server. For example, a selection module of the Fv is configured with an intelligent module for independently calculating and determining a value score from the Fv perspective whether to confirm the requests. In other words, the Lv, Fv, and the ODA server each are configured to determine an individual value score that is best suited for each other and may/may not be the same value score across all three entities, and negotiate in a limited time a confirmation and approval of the ODA service request. In an embodiment, the selection module of the Lv or Fv determines a value score which is personal or in either entities perspective (the Lv or Fv) based on the broadcast information received from the ODA server that includes a cost metric of an amount provided by the ODA service for the Lv to perform the control of the Fv to the requested location or for the Fv to request the ODA service from the Lv. The value score is an independently calculated score of value based on factors associated directly with the Lv or Fv operation for the ODA service request from each entities perspective, that can include as an example, the current location, time to travel to the pick up location, opportunity costs to wait for another ODA request, etc. for one or both of the entities.

At step 1245, the indication module indicates the vehicle positioning of the Fv to the ODA service for various actions during the ODA service. For example, the indication module may control light operations to indicate a linking and unlinking leg of operation, and to keep other traffic away from or to warn of a certain state of operation in the ODA service.

In various embodiments, the Fv is categorized as a level two vehicle with at least the capability to communicate with the ODA server, to create a virtual link with a leader vehicle (Lv), and to relinquish control to the Lv in a vehicle platoon. The Lv is at least categorized as the level two vehicle with at least the capability to communicate with the ODA server, to create the virtual link with the Fv, and to perform the control of the Fv for the ODA service. The Fv to in the vehicle platoon is provided with simulated vehicle operations of a high level of autonomous driving capability without the Fv having been actually configured with the high level of autonomous driving capability.

At step 1250, once the link has been confirmed, the Fv has accepted (and the Lv has mutually accepted), the vehicle platoon is configured and the virtual tow of the Fv is commenced for the route. The Fv relinquishes control to the Lv for the route.

It should be appreciated that the process of FIG. 12 may include any number of additional or alternative tasks, the tasks are shown in FIG. 12 need not be performed in the illustrated order, and the process of FIG. 12 may be incorporated into a more comprehensive procedure or process having additional functionality not described in detail herein. Moreover, one or more of the tasks shown in FIG. 12 may be omitted from an embodiment of the process shown in FIG. 12 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It is understood that various changes may be made in the function and arrangement of elements described in an exemplary aspect without departing from the scope of the invention as set forth in the appended claims.

What is claimed is:

1. An On-Demand Autonomy (ODA) system, comprising:
a set of functional modules enabled for ODA service activities disposed in a follower vehicle (Fv) in communication with an ODA server comprising at least a user request module, a schedule module, a schedule execution module, and an indication module, wherein the set of functional modules further comprise:
the user request module configured to, by a processor, receive request information from the Fv from the ODA server, and to process and communicate the request information to the schedule module;
the schedule module configured to, by the processor, coordinate an arrival time information with the ODA server for pickup of the Fv based on the request information, and communicate the arrival time information to the schedule execution module;
the schedule execution module configured to, by the processor, direct the Fv to a pickup point based on the arrival time information, and communicate the pickup point to the indication module; and
the indication module configured to, by the processor, provide alerts to vehicles in a vicinity of the pickup of the Fv via the ODA service.

2. The system of claim 1, further comprising:
the user request module configured to, by the processor, send automatically an offer or an alert to use the ODA service to the Fv by the ODA server based on a set of criteria associated with received operating data of vehicle behavior of the Fv wherein the operating data of vehicle behavior is monitored by the ODA server when the Fv is connected to the ODA service but not using the ODA service.

3. The system of claim 1, further comprising:
the user request module configured to, by the processor, proactively suggest use of the ODA service to the Fv by communications from the ODA server based on learned data from artificial intelligence model, or a machine learning model of data associated with Fv operations.

4. The system of claim 1, further comprising:
the schedule module configured to, by the processor, determine by an iterative process pairing of the Fv based on a value score which is cost-benefit assessment using a set of modeled weighted factors of the Fv that is independently computed by the Fv, and coordinating requests between the Fv and one or more leader vehicles (Lvs) to confirm acceptance of a virtual link between the Fv and Lv to create a vehicle platoon.

5. The system of claim 1, further comprising:
the schedule module to enable selection of a schedule for the Fv and configured to, by the processor:
receive schedule information associated with costs from the ODA server which have been calculated based on a complex function comprising at least end to end time; and
present a set of options to the Fv for the selection wherein the set of options comprise start and endpoint of the ODA service, and a number of transfers, if necessary, with multiple leader vehicles (Lvs).

6. The system of claim 1, further comprising:
the schedule execution module configured to, by the processor, initiate a schedule and virtual link between the Fv to a leader vehicle (Lv), and monitor with continuous status updates operations of the Fv for at least an unlink action at an end of a route.

7. The system of claim 1, wherein the Fv is at least categorized as a level two vehicle with at least capability to communicate with the ODA server, to create a virtual link with a leader vehicle (Lv), and to relinquish control to the Lv in a vehicle platoon.

8. The system of claim 7, wherein the Lv is at least categorized as the level two vehicle with at least a capability to communicate with the ODA server, to create the virtual link with the Fv, and to perform the control of the Fv for the ODA service.

9. The system of claim 1, further comprising:
the indication module configured to, by the processor, indicate vehicle positioning of the Fv to the ODA service for at least a linking operation to create a virtual link.

10. The system of claim 9, wherein the virtual link enables the Fv to simulate vehicle operations of a higher level of autonomous driving capability without the Fv having been actually configured with the higher level of autonomous driving capability.

11. A method for an On-Demand Autonomy (ODA) service, comprising:
configuring a set of functional modules comprising at least a user request module, a schedule selection module, a schedule execution module, and an indication module for ODA service activities disposed in a follower vehicle (Fv) for communicating with an ODA server by:
configuring the user request module, by a processor, for receiving request information from the Fv from the ODA server, and for processing and communicating the request information to the schedule selection module;
configuring the schedule selection module, by the processor, for coordinating an arrival time information with the ODA server for picking up of the Fv based on requesting information, and communicating the arrival time information to the schedule execution module;
configuring the schedule execution module, by the processor, for directing the Fv for picking up at a point based on the arrival time information, and for communicating a pickup point to the indication module; and
configuring the indication module, by the processor, for alerting vehicles in a vicinity of picking up of the Fv via the ODA service.

12. The method of claim 11, further comprising:
sending by the user request module, by the processor, automatically an offer or an alert for using the ODA service to the Fv by the ODA server based on a set of criteria associated with operating data of vehicle behavior of the Fv wherein the operating data of vehicle behavior is monitored by the ODA server.

13. The method of claim 11, further comprising:
suggesting by the user request module, by the processor, use of the ODA service to the Fv by communications from the ODA server based on learned data from artificial intelligence model, or a machine learning model of data associated with Fv operations.

14. The method of claim 11, further comprising:
determining by the schedule selection module, by the processor, via an iterative process of a pairing of the Fv based on a value score which is cost-benefit assessment using a set of modeled weighted factors of the Fv that is independently computed by the Fv, and coordinating requests between the Fv and one or more leader vehicles (Lvs) to confirm acceptance of a virtual link between the Fv and Lv for creating a vehicle platoon.

15. The method of claim 11, further comprising:
selecting by the schedule selection module, by the processor, a schedule for the Fv by:
receiving schedule information associated with costs from the ODA server which have been calculated based on a complex function comprising at least end to end time; and
presenting a set of options to the Fv for user selection wherein the set of options comprise a start point and an endpoint of the ODA service, and a number of transfers, if necessary, with multiple leader vehicles (Lvs).

16. The method of claim 15, further comprising:
initiating by the schedule execution module, by the processor, the schedule and virtual link between the Fv to a leader vehicle (Lv), and monitoring with continuous status updates operations of the Fv for at least an unlink action at an end of a route.

17. The method of claim 11, wherein the Fv is at least categorized as a level two vehicle with at least a capability to communicate with the ODA server, to create a virtual link with a leader vehicle (Lv), and to relinquish control to the Lv in a vehicle platoon, and wherein the Lv is at least categorized as the level two vehicle with at least the capability to communicate with the ODA server, to create the virtual link with the Fv, and to perform the control of the Fv for the ODA service.

18. The method of claim 16, wherein the virtual link enables the Fv to simulate vehicle operations of a high level of autonomous driving capability without the Fv having been actually configured with the high level of autonomous driving capability.

19. The method of claim 11, further comprising:
indicating by the indication module an appropriate positioning of the Fv to the ODA service for at least a linking/unlinking operation to create/release a virtual link between the Fv and Lv.

20. An autonomous vehicle configured for a follower vehicle (Fv), comprising:
a processor in communication with an On-Demand Autonomy (ODA) server comprising a set of functional modules of at least a user request module, a schedule selection module, a schedule execution module, and an indication module for ODA service activities comprising creation of a virtual link to the Fv to configure a vehicle platoon disposed in a follower vehicle Fv wherein the virtual link enables the Fv to simulate vehicle operations of a high level of autonomous driving capability without the Fv configured for the high level of autonomous driving capability, the processor configured to:
receive, by the user request module, information of requests from the Fv from the ODA server, and to process and communicate the information of the requests to the schedule selection module;
coordinate, by the schedule selection module an arrival time information with the ODA server to pick up the Fv based on requested information, and communicate the arrival time information to the schedule execution module;
direct by the schedule execution module, the Fv to pick up at a point based on the arrival time information, and to communicate a pickup point to the indication module; and
alert by the indication module, vehicles in a vicinity of the pickup at the point of the Fv via the ODA service.
